(19) United States
(12) Patent Application Publication
(10) Pub. No.: US 2025/0170743 A1
(43) Pub. Date: May 29, 2025

(54) METHOD FOR DETERMINING A MACHINING PROFILE OF A STAVE AND ASSOCIATED MACHINING MACHINE

(71) Applicant: MONNOT LMT, Beaune (FR)

(72) Inventor: Olivier CASIER, Nuits-Saint-Georges (CN)

(21) Appl. No.: 18/952,341

(22) Filed: Nov. 19, 2024

(30) Foreign Application Priority Data
Nov. 24, 2023 (FR) 2313053

(51) Int. Cl. B27H 3/02; B65D 8/00

(52) U.S. Cl. CPC B27H 3/02; B65D 9/04

(57) ABSTRACT

The present invention relates to a method for determining a profile for machining a stave from a strip of wood. For this purpose, computer means obtain a first piece of data representative of a wood strip profile and determine a second piece of data representative of said machining profile according to said first piece of data, said machining profile being inscribed in said wood strip profile and having a width changing along said stave. Said machining profile has a neutral axis having a non-rectilinear shape over the width of said stave, so that said machining profile follows said wood strip profile, maximizes the stave width and minimizes the losses of material between said strip of wood and said stave.

### BACKGROUND

### 1. Technical Field

The present invention relates to the machining of rough staves for the manufacturing of staves, which are used for the manufacturing of barrels or casks, as well as tanks.

The present invention relates more particularly to a method for determining a machining profile of the lateral edges of a stave allowing to minimize the losses of material associated with the machining, as well as a machining machine implementing such a method, in particular a machining machine equipped with associated machining means. The present invention also relates to a stave, the machining profile of its lateral edges of which allows to minimize the losses of material associated with the machining, called curved stave, as well as a method for manufacturing barrels using a curved stave.

The present invention thus has numerous advantageous uses in the field of woodworking and coopering.

### 2. Prior Art

The shell of a barrel or cask is manufactured from staves, for example approximately thirty staves, and metal hoops of different diameters. The staves are disposed next to one another and touching inside an end metal hoop on a first side, which allows to form a cone. Then one or two intermediate metal hoops having increasing diameters are inserted by force around the staves on this first side, which allows to form a stable structure. After bending of the flared part of the cone by addition of water and heat, and obtaining the shape of the barrel or cask via a cable or jaws allowing to make the staves also touching on the second side, metal hoops are also driven around the staves on this second side, which allows to definitively form the shell of said barrel. Two heads then close the shell of the barrel at its two end peripheral edges.

In France, staves are manufactured by machining of pieces of wood called rough staves. The rough staves are boards obtained by splitting of oak logs according to the direction of the fibers and the medullary rays, in order to ensure the sealing and the mechanical strength thereof. This type of oak wood is of the best quality and thus has a high cost.

The rough staves have a substantially parallelepipedic or even trapezoidal overall shape having a known length, but a variable width since they are manually cut according to the dimensions of the quarter bolts of oak and the defects present in the wood. These rough staves can have curvatures and warping.

In the United States, the machining of staves is carried out using sawed wood. The oak logs are sawed successively into quarters, then into a plurality of strips of wood. In particular, this sawing does not follow the grain of the wood. When the wood dries before machining, the numerous cut grains result in a pronounced and frequent curvature of the strips of wood. Such a drying also results in curvatures, although less pronounced, for the rough staves manufactured according to the French methods.

The strips of wood or rough staves (hereinafter designated as “strips of wood”) are then machined on their six faces in several steps in order to obtain staves. A first step involves trimming the strip of wood by double sawing at its two longitudinal end edges, which allows the strip of wood to have a defined length, while its width is variable. A second step involves a backing operation according to which the strip of wood is machined to be rounded, with a convex shape, on its outer face used to form the outer wall of the shell of the barrel or cask. A third step involves an inclination operation according to which the strip of wood is machined with an oblong profile in the direction of its length and with an inclined profile in the direction of its width, on its two lateral edges which will be in contact with the neighboring staves during the formation of the shell. A fourth step involves a hollowing operation according to which the strip of wood is machined to be hollow over all or a part of the length and with a concave shape, on its inner face forming the inner wall of the shell of the barrel or cask.

For the manufacturing of barrels or casks, the oblong shape obtained during the inclination operation is characterized by three zones, namely: two “heads” corresponding to the two parts of longitudinal ends of the stave and a “bilge” corresponding to the most swollen central part of the stave.

For the manufacturing of tanks from staves, in particular tapered tanks, the oblong shape has a foot, having a maximal width, at a first longitudinal end, and a head, having a minimal width, at an opposite second longitudinal end. Moreover, tapered tanks generally correspond to containers having significant dimensions, for example having a capacity of 10 to 50 hectoliters. The manufacturing of tapered tanks thus requires very long strips of wood, in which any curvature will have a very significant impact.

According to the prior art, the inclination operation can be obtained on various types of machines. Certain machines are mechanical; the oblong profiles are obtained by controlling machining spindles via a cam. Other machines are digital; the oblong profiles are obtained by controlling machining spindles via a robot or a computer.

The requirements of material yield, because of the cost of the top-quality oak used, require coopers to be careful to minimize the quantity of wood consumed by machining of each lateral edge of the strip of wood, so as to use the least amount of staves as possible for the manufacturing of the barrel, cask or tank.

The document FR3023742B1 thus seeks to reduce as much as possible the chips of material during the machining of the lateral edges by proposing a more accurate measurement of the lateral edges of the rough stave. Such a solution thus allows to avoid measurement errors and better take into account the variations in width and in geometry of the rough stave.

The applicant holds, however, that this solution only allows to obtain a better visualization of the shape of the rough stave, without a true improvement in terms of the cut itself.

In particular, and as mentioned above, the strips of wood have variable shapes and widths resulting from their manual cutting or sawing, as well as from the drying before machining, and are in particular capable of having curvatures or warping. The creation of the stave, in particular the inclination, only involves obtaining a stave shape inscribed in the profile of the strip of wood. Thus, if the strip of wood has a shape greatly differing from the oblong profile desired for the stave, the machining of the rough stave results in significant losses of material. The applicant thus estimates that the quantity of loss of material resulting from the manufacturing of staves from strips of wood having a crook, that is to say a curve making the lateral edges concave or convex, is 20%. Moreover, certain strips of wood having too much curvature are considered to be entirely unusable for the manufacturing of staves.

It is also known to carry out an operation before the machining of the strip of wood, in which the latter is “corrected” in order to correct its curvature, in particular by compressing the strip of wood according to a straight shape allowing an ideal machining. Such an operation consumes a lot of energy, however, and is not implemented in practice.

The applicant consequently holds that at present there is no satisfactory alternative solution allowing to obtain staves from strips of wood while minimizing the quantity of raw wood to be removed.

### SUMMARY

The present invention seeks to improve the current situation described above.

The present invention aims more particularly to overcome the above disadvantages by proposing a solution for machining a stave from a strip of wood that determines, according to the strip of wood, the stave profile requiring the least loss of material.

It is understood here, as mentioned above, that the strip of wood corresponds to a piece of wood intended to be machined for the manufacturing of a barrel, a cask or a tank. The strip of wood is for example obtained by the methods for manufacturing rough staves or from quarter-sawn wood, as described in the prior art, or any other means known to a person skilled in the art.

For this purpose, the object of the present invention relates in a first aspect to a method for determining a profile for machining a stave from a strip of wood, the method being implemented by at least one processor, the method comprising the following steps:
obtaining a first piece of data representative of a wood strip profile;
determining a second piece of data representative of the machining profile according to the first piece of data, the machining profile being inscribed in the wood strip profile and having a width changing along the stave.

It is understood here that the first piece of data is for example received from measurement means integrated into or in communication with the processor, or from computer means in communication with the processor, for example having determined the first piece of data after processing of measurements carried out on the strip of wood.

It is considered here and throughout the description that follows that the notions of length, width and thickness of the strip of wood and of the stave are understood in such a way that, when taking as a reference a barrel assembled from staves, the length of the stave corresponds to its greatest dimension and extends according to the height of the barrel, the thickness of the stave corresponds to its smallest dimension and extends according to the thickness of the barrel and the width of the stave corresponds to its intermediate dimension and extends according to the circumference of the barrel. Thus, the length and the width define the faces (also called “flat side”) of the stave, the width and the thickness define the ends of the stave, and the length and the thickness define the (lateral) edges of the stave. Such a reasoning applies similarly when taking as a reference a tapered tank assembled from staves.

It is also understood that the machining profile corresponds to the profile used during the inclination operation as described above, that is to say the machining of the lateral edges of the stave, in particular so as to define the contour of the face of the stave.

As described above and known in the prior art, the machining profile is determined, for a stave suitable for the manufacturing of barrels, so that the stave has a “bilge” corresponding to a central part, according to its longitudinal direction, and the width of which is maximal, as well as two “heads” corresponding to the longitudinal ends of the stave, and the width of which is minimal. The width of the heads is for example equal. The machining profile is also determined so that the width of the stave decreases between the bilge and the heads, for example with a faster reduction of the width when moving away from the bilge.

In a second scenario corresponding to a stave adapted to the manufacturing of tapered tanks, the machining profile is determined so that the stave has a “foot” corresponding to a first longitudinal end of the stave, the width of which is maximal, and a “head” corresponding to a second longitudinal end of the stave, the width of which is minimal. The machining profile is also determined so that the width of the stave decreases between the foot and the head, for example with a faster reduction of the width when moving away from the foot.

The machining profile thus corresponds to a profile for machining the lateral edges of the stave. Likewise, the first piece of data is representative in particular of the lateral edges of the wood strip profile.

Advantageously, the machining profile has a neutral axis having a non-rectilinear shape over the width of the stave, so that the machining profile follows the wood strip profile, maximizes the stave width and minimizes the losses of material between the strip of wood and the stave.

Neutral axis means in the sense of the present invention the intermediate axis of the stave according to its width, that is to say a line along the length of the stave and disposed at equidistance from the lateral edges of the stave. In a stave of the prior art, called “straight stave”, such a neutral axis is rectilinear forming an axis of symmetry of the lateral edges, which have a simple oblong shape.

The machining profile is thus no longer constrained by a rectilinear neutral axis shape, allowing to adapt it more precisely to the wood strip profile, in particular so as to follow the curvature of the strip of wood. The machining profile consequently becomes mainly constrained by the inscription, along the stave, of the width of the stave in the width of the strip of wood.

Preferably, the neutral axis has a curved shape. In other words, the neutral axis follows a curved line. The neutral axis thus differs from a broken line, that is to say from a set of sections of a rectilinear neutral axis.

It is also understood that the method according to the invention does not aim to propose a stave having a specific final shape, but on the contrary a stave, the profile of the lateral edges of which adapts more precisely to the profile of the lateral edges of the strip of wood. The machining profile shares for example a width with the wood strip profile, corresponding to the longitudinal portion of the strip of wood for which it is not necessary to carry out a cut—a superficial surface planing sufficing—to obtain the change in width sought along the stave. In other words, the ideal machining profile only reduces the width of the strip of wood along its profile, while being constrained in a longitudinal portion, for which no reduction of the width is necessary. A person skilled in the art also understands that the machining of the lateral edges is determined so that the lateral edges are inclined according to the thickness of the stave, in other words that the profile of an “outer” face of the stave has a greater width than the “inner” face, thus reflecting the change in the perimeter of a barrel between its outer and inner faces. In practice, the machining of the lateral edges of the strip of wood is thus carried out according to its entire length.

Via the present invention, the losses of material are limited by proposing a machining profile, the lateral edges of which are closer to the profile of the lateral edges of the strip of wood. Of course, the losses of material associated with each strip of wood depend on its specific profile, and are not fixed from one strip of wood to another. Thus, if the present invention arrives at results similar to the prior art with regard to strips of wood having low or no curvature, the applicant holds that the present invention allows a gain of material between 5 and 10% with respect to the prior art on the machining of curved strips of wood, and allows the machining into staves of strips of wood previously unusable via the techniques known from the prior art (theoretically corresponding to a gain of material of 100% with respect to a strip of wood entirely scrapped).

The applicant further holds that a stave obtained by the method according to the invention, that is to say a curved stave as described below, can be used in a method for manufacturing barrels, casks or tanks, without loss of material or additional energy consumption.

In particular, the operations of bending described above with regard to the manufacturing of barrels from staves, and also implemented during the manufacturing of tapered tanks from staves, naturally result in a “straightening” of a curved stave when the latter is juxtaposed with other straight staves. On the contrary, when a set of curved staves are used for the manufacturing of the same barrel, cask or tank, their curvature is maintained during the bending operation, resulting in a “coiled” barrel, without affecting the sealing or the mechanical strength of the barrel, cask or tank obtained. Thus, the method according to the invention allows to obtain a curved stave directly usable in the methods for manufacturing barrels, casks or a tank, without adaptation required, and while minimizing the losses of material.

In an advantageous embodiment of the invention, the obtaining comprises a step of receiving a piece of dimensional information associated with a plurality of points of the wood strip profile.

The piece of dimensional information is for example received from measurement means in communication with the processor. The measurement means correspond for example to a plurality of rollers disposed along the strip of wood, on each side of the latter, for example three sets of rollers respective associated with the bilge and with the heads of the strip of wood, or any other section near the heads of the strip of wood. Of course, it is also possible to design measurement means allowing the determination of a greater number of points of the wood strip profile. For example it is possible to provide two rollers respectively disposed on the lateral sides of the strip of wood and moving over its entire length to measure the width of the strip of wood, or even two rollers respectively disposed on the lateral sides of the strip of wood and measuring the width of the strip of wood during the forward movement of the strip of wood, placed between the two rollers, over its entire length. It is also possible to provide any system for optical, contact or other profilometry known to a person skilled in the art.

The piece of dimensional information corresponds for example to a measurement of width of the strip of wood at several points disposed according to the length of the strip of wood. According to another example, the piece of dimensional information corresponds to a measurement of position of a set of points disposed along the lateral edges of the strip of wood. The profile of the strip of wood can be determined from such a set of points for example by interpolation.

It is further understood that the piece of dimensional information is mainly associated with a measurement of width, or at the very least of a disposition of the points of the strip of wood according to a transverse axis of the strip of wood. In particular, as described above, the length of the strips of wood is generally known in advance and does not require an additional measurement.

Preferably, the obtaining further comprises a step of modelling the wood strip profile according to the piece of dimensional information.

The modelling of the wood strip profile corresponds for example to an interpolation, in particular a circular interpolation or a polynomial interpolation, from the set of measured points of the strip of wood.

In one embodiment, the wood strip profile and/or the machining profile are modelled by circular interpolation.

In an additional embodiment, the wood strip profile and/or the machining profile are modelled by the use of polynomial equations having a degree greater than or equal to 2.

The wood strip profile and the machining profile are for example both modelled similarly in order to facilitate the determination of the machining profile. The polynomial equations and/or the circular interpolation can be used to model the lateral edges of the strip of wood, of the machining profile, as well as to model the neutral axis.

Likewise, the neutral axis can also be modelled by circular interpolation and/or according to a polynomial equation having a degree greater than or equal to 2.

A person skilled in the art understands that circular interpolation is routinely used in the techniques of machining by interpolation. The modelling of the machining profile, in particular, by circular interpolation thus directly allows its use in the context of a machining with digital control, for example by adjusting a routing of the lateral edges of the strip of wood.

The applicant further holds that the use of polynomial equations having a degree equal to 2 corresponds, for the solutions implementing a polynomial equation, to the simplest solution for modelling a wood strip and/or machining profile having a curved shape, and thus taking into account the curvature of the strip of wood, without having oscillations. The use of polynomial equations having a greater degree is however also possible, according to the quantity of information available for the modelling, optionally allowing a more precise modelling of the actual shape of the strip of wood and consequently the obtaining of a more optimized stave profile resulting in a reduced loss of material.

It is further understood that the use of polynomials of at least the second degree is indispensable for arriving at stave shapes having the desired change in width.

In an additional embodiment, the method further comprises a reception of a third piece of data representative of a goal for shape of the stave, the second piece of data being further determined according to the third piece of data.

Preferably, the third piece of data comprises a piece of information representative of a ratio between two widths of the stave, the second piece of data being further determined according to the ratio.

In accordance with the above description, the ratio corresponds according to a first example to a ratio between a bilge width of the stave and a width at the ends of the stave. According to a second example, the ratio corresponds to a ratio between a foot width and a head width of the stave.

It is understood here that, if each stave necessarily has a bilge width greater than the width of the heads, or a foot width greater than the head width, the ratio between these widths can be greater or lesser, affecting the final curvature of the barrel or of the tank. This ratio is, likewise, also affected by the length of the stave. Thus, just like the length of the stave, the ratio corresponds to a parameter allowing the determination of the stave profile, which is capable of changing according to later goals regarding the shape of the barrel or of the tank, that is to say that the stave profile depends on the desired shape of the barrel, of the cask or of the tank. Each barrel, cask or tank is for example associated with a specific ratio, corresponding to its own curvature.

In other words, each barrel, cask or tank has physical characteristics, the third piece of data comprising information representative of physical characteristics necessary for the stave to be able to be used for the manufacturing of a barrel, of a cask or of a given tank. The third piece of data also comprises for example a piece of information representative of shape of the stave, allowing to determine whether the stave profile corresponds to that of a stave for a barrel, having a bilge and two heads, or to that of a stave for a tapered tank, having a foot and a head.

In another embodiment, the method further comprises a step of transmitting the second piece of data to machining means.

It is understood here that the method is designed so as to generate an electronic signal capable of controlling machining means, or capable of being interpreted by means for controlling the machining means.

In another embodiment, the method further comprises a step of machining the strip of wood for the manufacturing of the stave according to the second piece of data, via machining means.

It is understood here that the method according to the invention corresponds to a broader stave manufacturing method, which includes steps of determining the profile of the stave lateral edges before its machining. The method includes for example other operations of machining the strip of wood, in particular so as to reproduce all of the steps known to a person skilled in the art and described with regard to the prior art, in which the operation of inclination is carried out according to the second piece of data.

According to a second aspect, the present invention relates to a computer program including instructions for the implementation of the method according to the first aspect of the present invention, when these instructions are executed by a processor.

According to a third aspect, the present invention relates to a recording medium readable by a computer on which a computer program comprising instructions for the execution of the steps of the method according to the first aspect of the invention is recorded.

On the one hand, the recording medium may consist of any entity or device capable of storing the program. For example, the medium may include a storage means, such as a ROM memory, a CD-ROM or a ROM memory of the microelectronic circuit type, or a magnetic recording means or a hard disk.

On the other hand, this recording medium may also consist of a transmissible medium such as an electrical or optical signal, such a signal could be routed via an electrical or optical cable, by conventional radiofrequency or hertzian waves or by a self-steering laser beam or by other means. In particular, the computer program according to the present invention may be downloaded on an Internet-type network.

Alternatively, the recording medium may be an integrated circuit in which the computer program is incorporated, the integrated circuit being adapted to execute or to be used in the execution of the considered method.

According to a fourth aspect, the present invention relates to a machine for machining a strip of wood for the manufacturing of a stave. Moreover, the machine comprises computer means configured for the implementation of the method according to the first aspect of the present invention, as well as machining means controlled by the computer means.

It is understood here that the computer means are configured to communicate with or control the machining means, and that the machine is configured to machine a strip of wood for the manufacturing of a stave according to the second piece of data via the machining means.

The computer means comprise for example a tag unit configured to obtain a first piece of data representative of a wood strip profile, and a processing unit configured to determine a second piece of data representative of the machining profile according to the first piece of data.

Of course, the machining machine can comprise a plurality of other elements known to a person skilled in the art for the manufacturing of staves, allowing to carry out a plurality, or even all of the steps of machining strips of wood for the manufacturing of staves.

According to a fifth aspect, the present invention relates to a stave for the manufacturing of barrels, the stave having a stave profile defining a neutral axis having a non-rectilinear shape in the direction of the width of the stave.

It is understood here that the stave has a stave profile that is preferably determined by the method according to the first aspect of the present invention. The stave is for example obtained by executing the method according to the first aspect of the present invention and/or by the machining machine according to the fourth aspect of the present invention. The stave thus corresponds to a curved stave, that is to say a stave, the neutral axis of which follows a curved trajectory.

According to a sixth aspect, the present invention relates to a method for manufacturing a barrel or tank from a plurality of staves, wherein the plurality of staves comprises at least one stave having a stave profile defining a neutral axis having a non-rectilinear shape in the direction of the width of the stave, called curved stave.

It is understood here that the method for manufacturing a barrel or tank corresponds to a method known to a person skilled in the art, for example the method as described with regard to the prior art or any other method known from the prior art, the method for manufacturing a barrel or tank being implemented using a set of staves, including at least one curved stave. As mentioned above, according to the number of curved staves and straight staves used for the manufacturing of the barrel or of the tank, the bending operation results alternatively in a straightening of the curved stave(s), making them adopt the shape of a straight stave and resulting in a barrel or a tank having an appearance indistinguishable from those of the prior art, or in the adoption of a more or less pronounced curve over all of the staves, resulting in a barrel or a tank having a “coiled” appearance but having the same physical properties as those of the prior art.

Thus, by the various functional and structural technical characteristics above, the applicant proposes a method for determining a stave machining profile and a machining machine allowing an increased yield by adapting the machining to the shape of the strip of wood used, resulting in a curved stave, which can be used without difficulty in the conventional methods for manufacturing barrels.

### BRIEF DESCRIPTION OF THE DRAWINGS

Other features and advantages of the present invention will appear from the description of the specific and non-limiting exemplary embodiments of the present invention below, in reference to the appended FIGS. 1 to 10 in which:

FIG. 1 schematically illustrates a profile for machining a straight stave from a first strip of wood, according to the prior art;

FIG. 2 schematically illustrates a profile for machining a curved stave from a first strip of wood according to FIG. 1, according to an exemplary embodiment;

FIG. 3 illustrates a modeling of a profile for machining a straight stave from a second strip of wood, according to the prior art;

FIG. 4 illustrates a modeling of a profile for machining a curved stave from a second strip of wood according to FIG. 3, according to an exemplary embodiment;

FIG. 5 illustrates a modeling of a profile for machining a straight stave from a third strip of wood, according to the prior art;

FIG. 6 illustrates a modeling of a profile for machining a curved stave from a third strip of wood according to FIG. 5, according to an exemplary embodiment;

FIG. 7 illustrates a modeling of a profile for machining a straight stave from a fourth strip of wood, according to the prior art;

FIG. 8 illustrates a modeling of a profile for machining a curved stave from a fourth strip of wood according to FIG. 7, according to an exemplary embodiment;

FIG. 9 schematically illustrates a device configured to determine a profile for machining a stave from a strip of wood, according to a specific and non-limiting exemplary embodiment of the present invention;

FIG. 10 illustrates a flowchart of the various steps of a method for determining a profile for machining a stave from a strip of wood, according to a specific and non-limiting exemplary embodiment of the present invention.

### DETAILED DESCRIPTION

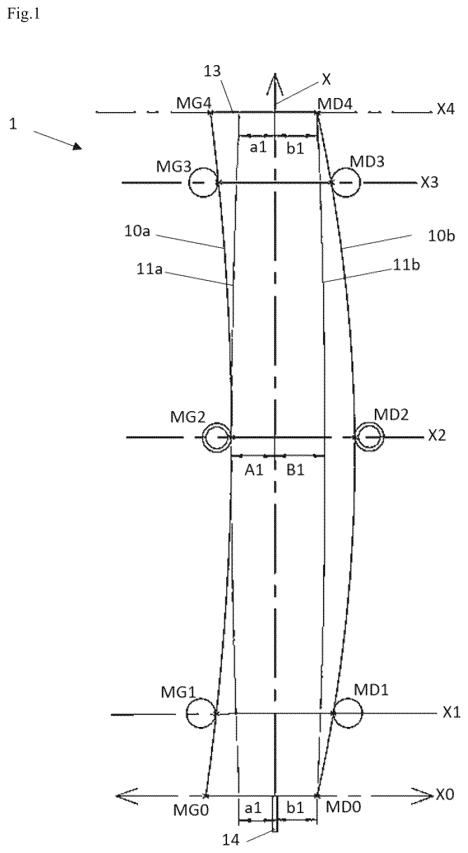

A method for determining a profile for machining the lateral edges of a stave, a machine for machining strips of wood to obtain staves, and a method for manufacturing a barrel will now be described below in reference jointly to FIGS. 1 to 10. The same elements are identified with the same reference signs throughout the following description.

As indicated in the preamble of the description, the current solutions for manufacturing staves from strips of wood result in significant losses of material, in particular when the strip of wood has curvatures.

One of the goals of the present invention is to propose a new profile for machining the lateral edges of a stave, adapted to the manufacturing of barrels, casks, tanks or other, and the manufacturing of which limits the losses of material. In the rest of the description, when it is not specified, the term profile refers to the shape of the lateral edges, whether this is for the strip of wood or for the stave.

This is made possible in the examples described below, which consider the machining of the lateral edges of a stave from a plurality of shapes of strips of wood, during the operation of inclination corresponding to the machining of the lateral edges of the strip of wood.

It is understood that these examples are not limiting and that the method according to the invention can be adapted to any shape of a strip of wood. The method according to the invention can also be integrated into a broader method for manufacturing staves, incorporating other steps known to a person skilled in the art, in particular steps of sawing, backing and hollowing.

According to the example of FIGS. 1, 3, 5 and 7, the operation of inclination of a strip of wood 1, 1′, 1″, 1′″ having a wood strip profile 10a, 10b comprises the machining of an oblong profile 11a, 11b inscribed in the wood strip profile 10a, 10b, that is to say the machining of the lateral edges of the strip of wood so as to form two curved symmetrical edges, the width of which decreases between the bilge and the heads, the symmetry of the oblong profiles 11a, 11b being defined with respect to a rectilinear neutral axis 11c. This inclination operation results in the formation of “straight” staves, which have a rectilinear neutral axis 11c.

This machining of the lateral edges naturally results in a loss of material, which is even more pronounced when the strip of wood 1, 1′, 1″, 1′″ has a shape notably different from a straight stave. In particular, the strip of wood 1, 1′, 1″, 1′″ can have a more or less pronounced curvature, resulting from its manual cutting, and the inscription of a straight stave in a curved profile involves significant losses of material.

Thus, according to the example of FIG. 1 associated with a stave for the manufacturing of barrels, the strip of wood 1 is aligned according to the longitudinal axis X forming an axis of symmetry of the stave to be machined, and the oblong profile 11a, 11b is defined with respect to the longitudinal axis X with a first lateral edge 11a having a lateral distance at the bilge A1 and a lateral distance at the heads a1, as well as a second lateral edge 11b having a lateral distance at the bilge B1 and a lateral distance at the heads b1, so that a1=b1, A1=B1, a1<A1, b1<B1 and a1+b1<A1+B1. It is further understood that, in the context of a stave for the manufacturing of tapered tanks, the same set of constraints between the lateral distances at the foot (replacing the lateral distances at the bilge) and the lateral distances at the head is obtained.

In order to propose a solution to this problem, a method for determining a profile for machining a stave is provided, for example the method 3 of FIG. 10. The method 3 is for example implemented by a machine for machining a strip of wood for the manufacturing of staves, the machining machine comprising computer means configured for the implementation of the method 3.

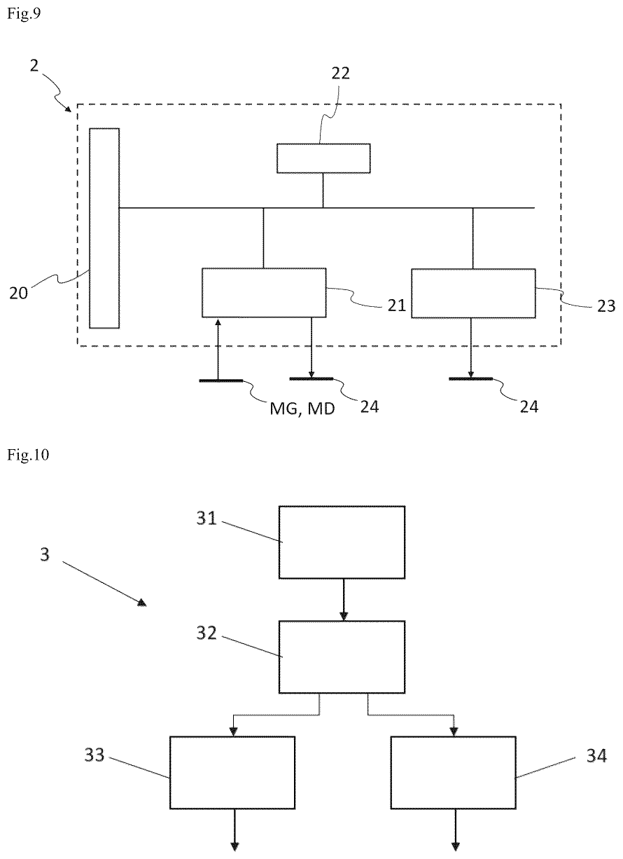

As illustrated in FIG. 9, such computer means are for example grouped together advantageously in an electronic device 2, for example a calculator (hereinafter designated as “calculator”). The calculator 2 is for example configured to transmit and receive data inside a communication network. The elements of the calculator 2, individually or in combination, can be integrated into a single integrated circuit, into several integrated circuits, and/or into discrete components. The calculator 2 can be carried out in the form of electronic circuits and software modules.

The calculator 2 comprises one (or more) processor(s) configured to execute instructions for the implementation of the steps of the method and/or for the execution of the instructions of the software onboard the calculator 2. The processor can include integrated memory, an input/output interface, and various circuits known to a person skilled in the art. The calculator 2 further comprises at least one memory 20 corresponding for example to a volatile and/or non-volatile memory and/or comprises a memory storage device that can comprise volatile and/or non-volatile memory, such as EEPROM, ROM, PROM, RAM, DRAM, SREAM, flash, magnetic or optical disk.

The computer code of the onboard software comprising the instructions to be loaded and executed by the processor is for example stored in the memory 20 of the calculator 2.

According to an alternative embodiment, the calculator 2 is configured for the implementation of a method for determining a profile for machining a stave from a strip of wood that is part of a broader method.

The method according to the invention is for example part of a method for communication with means for machining the stave. The method is for example implemented by an electronic device distinct from a machining machine and configured to communicate with the machining machine. According to another example, the method according to the invention is part of a method for machining a stave from a strip of wood, wherein the data determined during the method according to the invention, in particular the second piece of data described below, is used as a piece of input data for the machining of the stave.

In a first operation 31, the calculator 2 obtains a first piece of data representative of a wood strip profile 10a, 10b. In other words, the first piece of data allows to characterize the lateral edges of the strip of wood 1, 1′, 1″, 1′″.

The first operation 31 comprises for example a reception of a piece of dimensional information associated with a plurality of points of the wood strip profile 10a, 10b, that is to say a parameter, for example a position according to a lateral axis, associated with a plurality of measurement points. This plurality of points of the wood strip profile 10a, 10b is for example calculated via a measuring device described in the patent FR3023742B1.

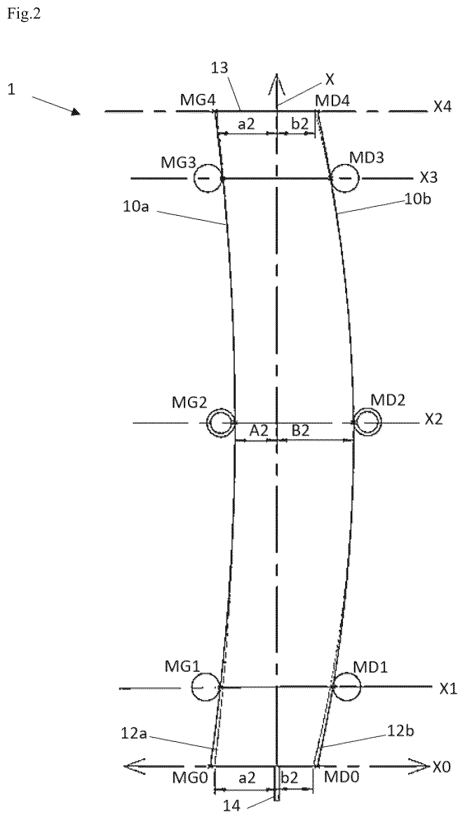

According to the example of FIGS. 1 and 2, the strip of wood 1 is disposed facing a machining machine via a dog 14 and aligned so as to extend according to a longitudinal axis X. The longitudinal end edges 13 of the strip of wood 1 are usually already sawed so that the strip of wood 1 extends according to a predefined length, in particular during its trimming by double sawing as known from the prior art.

The piece of dimensional information is thus received from measurement means GO, MD0, MG1, MD1, MG2, MD2, MG3, MD3, MG4, MD4 (or MG, MD overall), associated with the lateral edges of the strip of wood and disposed according to a plurality of longitudinal positions X0, X1, X2, X3, X4. The measurement means form here five sets disposed according to five longitudinal positions. Because of the difficulty of measuring at the end longitudinal positions X0 and X4, an alternative comprising three sets MG1, MD1, MG2, MD2, MG3, MD3, comprising for example rollers in contact with the strip of wood 1 associated with means for measuring the position of the rollers, is also provided. Or course, it is understood that it is possible to design a plurality of measurement means. It remains advantageous to dispose a first set of measurement means MG2, MD2 at the bilge X2 of the strip of wood, that is to say usually at mid-length of the strip of wood, and a second set of measurement means MG1, MD1, MG3, MD3 near the heads of the strip of wood 1, that is to say as close as possible to the longitudinal extreme positions X0, X4 of the strip of wood 1.

According to the example of FIG. 9, the piece of dimensional information is received by a tag unit 21 of the calculator 2, for example a tag unit 21 in communication with the measurement means MG, MD. The calculator 2 is for example in wired or wireless communication with the measurement means MG, MD.

After reception of the piece of dimensional information, the calculator 2 thus determines the wood strip profile 10a, 10b. The wood strip profile 10a, 10b is for example determined by a processing unit 22 integrated into the calculator 2, the processing unit 22 corresponding for example to an integrated processor.

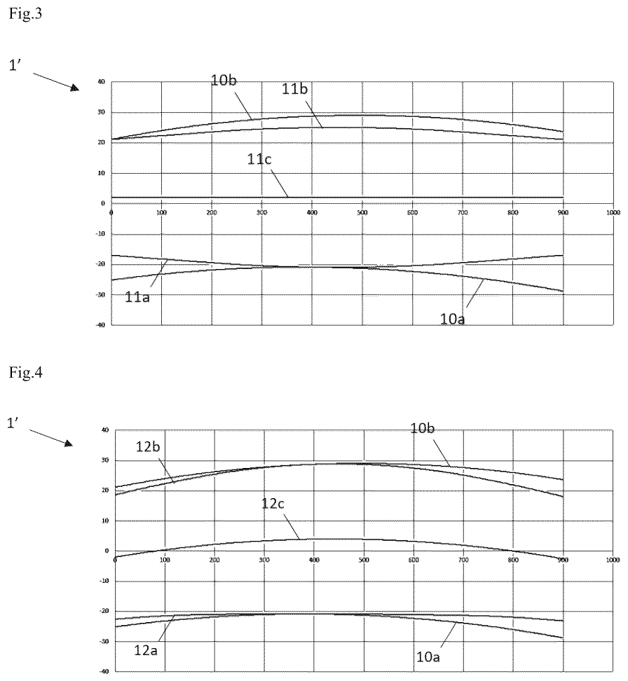

Optionally, the calculator 2, for example the processing unit 22, caries out a modeling of the wood strip profile 10a, 10b according to the piece of dimensional information. In particular, the wood strip profile 10a, 10b is advantageously modelled by the use of polynomial equations, that is to say that each lateral edge of the wood strip profile 10a, 10b is represented by a polynomial equation. According to another example, the wood strip profile 10a, 10b is modelled by circular interpolation, that is to say that each lateral edge of the wood strip profile 10a, 10b is modelled like the curvature of a circle having a given center and radius. FIGS. 3 to 8 thus illustrate a plurality of strips of wood 1′, 1″, 1′″, the curvature of which is modelled via a pair of polynomial equations or by circular interpolation. The calculator 2 carries out for example a polynomial or circular interpolation from the plurality of points characterized above. It is understood that, to adequately represent the curvature of the strip of wood 1, 1′, 1″, 1′″, it is necessary to measure the position of at least three points of each lateral edge, so as to obtain polynomials having a degree greater than or equal to 2.

According to another alternative, the tag unit 21 directly receives the first piece of data comprising a piece of information representative of a wood strip profile 10a, 10b, for example by communication with measurement means integrating calculation means configured to determine the wood strip profile 10a, 10b.

It would be possible to provide another alternative providing a relative movement between a set of two rollers each disposed on a lateral edge of the strip of wood and said strip of wood, so that the set of rollers moves relatively along the length of the strip of wood, thus allowing to calculate the exact coordinates of the positions of the lateral edges of the strip of wood over its entire length, said coordinates being transmitted to the calculator 2 which thus directly has available the wood strip profile 10a, 10b, forming the first piece of data.

In a second operation 32, the calculator 2, for example the processing unit 22, determines a second piece of data representative of a machining profile 12a, 12b according to the first piece of data.

The determination of the second piece of data thus corresponds to the establishment of a machining profile 12a, 12b inscribed in the wood strip profile 10a, 10b, the machining profile 12a, 12b allowing to obtain a stave. In the example of FIGS. 1 to 8, the machining of a stave for the manufacturing of barrels is provided. In such an example, the machining profile 12a, 12b requires having a decreasing width between the bilge X2 and the longitudinal ends X0, X4, so as to allow the later bending of the stave resulting in a barrel wider at mid-height than at the ends. According to another example of machining of a stave for the manufacturing of tapered tanks, the machining profile 12a, 12b requires having a decreasing width between a first longitudinal end X0 (corresponding to the “foot”) and a second longitudinal end X4 (corresponding to the “head”).

Of course, other parameters known to a person skilled in the art can also influence the determination of the machining profile. Optionally, the calculator 2, for example the tag unit 21, receives a third piece of data representative of a goal for shape of the stave, the second piece of data being further determined according to the third piece of data. The third piece of data comprises for example a piece of information representative of the type of stave to be machined, for example a stave for the manufacturing of barrels according to FIGS. 1 to 8 or a stave for the manufacturing of tapered tanks. The third piece of data also comprises for example a ratio between two widths of the stave, for example between a bilge width and a width at the ends of the stave, or any other parameter allowing to specify at which point the width of the stave must change along its longitudinal axis. In the context of a stave for the manufacturing of tapered tanks, this ration corresponds for example to a ratio between a foot width and a head width of the stave, that is to say a ratio between the width of the stave according to its two ends.

In accordance with the preceding alternative, the determination of the machining profile 12a, 12b comprises for example a modeling of the lateral edges of the stave via polynomial equations, or by circular interpolation, in particular so as to facilitate the comparison between the wood strip profile 10a, 10b and the machining profile 12a, 12b, via similar representations.

A person skilled in the art understands here that the circular interpolation corresponds to describing a lateral edge as an arc of a circle having a radius R and the center of which is given by a pair of coordinates (x0, y0), the lateral edge being represented by a function f(x)=y so that:

$$R = \sqrt{{( x - x 0 )}^{2} + {( y - y 0 )}^{2}} \qquad [ Math 1 ]$$

In accordance with the underlying concept of the invention and as illustrated in FIGS. 4, 6 and 8, the machining profile 12a, 12b is determined with a non-rectilinear neutral axis 12c in the direction of the width of the stave, that is to say without a constraint on the obtaining of a final oblong shape. The neutral axis 12c is for example also modelled via a polynomial equation, via circular interpolation, or via any other means allowing to determine a curvature thereof in the direction of the width of the stave. In other words, and as illustrated in FIG. 2 also associated with a stave for manufacturing of barrels, the longitudinal axis X no longer forms an axis of symmetry of the stave to be machined, and the machining profile 12a, 12b is defined with respect to the longitudinal axis X with a third lateral edge 12a having a lateral distance at the bilge A2 and a lateral distance at the heads a2, as well as a fourth lateral edge 12b having a lateral distance at the bilge B2 and a lateral distance at the heads b2, so that A2+B2>a2+b2 but without a direct constraint between a2 and A2, b2 and B2, a2 and b2 or A2 and B2. It is also possible, according to yet another alternative, to define a machining profile 12a, 12b so that the lateral distances at the heads are not identical, provided that the total width respects the other constraints. It is further understood that, in the context of a stave for the manufacturing of tapered tanks, the same constraint between the lateral distances at the foot (replacing the lateral distances at the bilge) and the lateral distances at the head is obtained, the other constraints also being eliminated.

Of course, regardless of the constraints, the determination of the machining profile 12a, 12b aims to minimize the losses of material, that is to say to produce the widest possible stave. The design with a non-rectilinear neutral axis 12c according to the invention thus allows to reduce the number of constraints on the machining profile 12a, 12b and to arrive at staves wider than in the prior art using a given strip of wood.

FIGS. 1 to 8 thus illustrate the comparative results, for four shapes of strips of wood 1, 1′, 1″, 1′″, between an oblong profile 11a, 11b as known from the prior art and a machining profile 12a, 12b obtained according to the invention. In particular, the first strip of wood 1 illustrates an almost perfect coincidence between the wood strip profile 10a, 10b and the machining profile 12a, 12b, resulting in almost null losses of material despite the curvature of the first strip of wood 1.

For the second strip of wood 1′ (FIGS. 3 and 4), the machining profile 12a, 12b has a width at the bilge greater by 4 mm with respect to the oblong profile 11a, 11b.

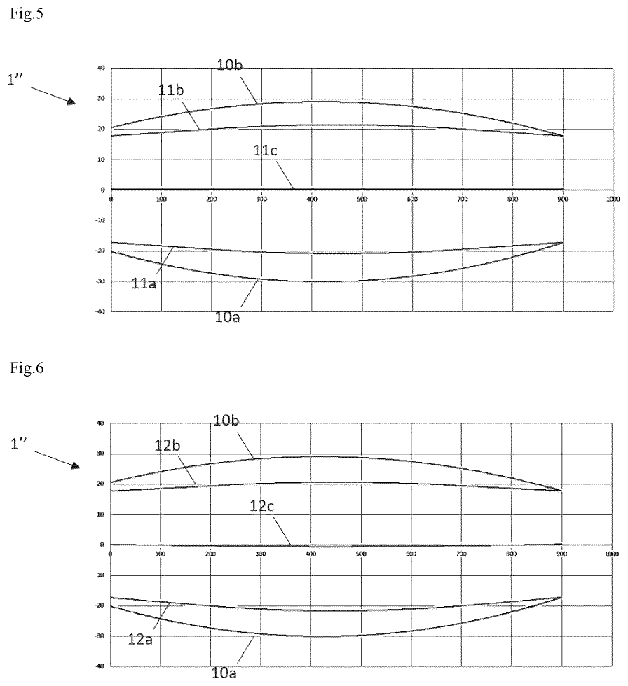

For the third strip of wood 1″ (FIGS. 5 and 6), the machining profile 12a, 12b has a width at the bilge substantially equal to that of the oblong profile 11a, 11b, the third strip of wood 1″ having a small curvature resulting in a non-rectilinear neutral axis 12c very close to the rectilinear neutral axis 11c.

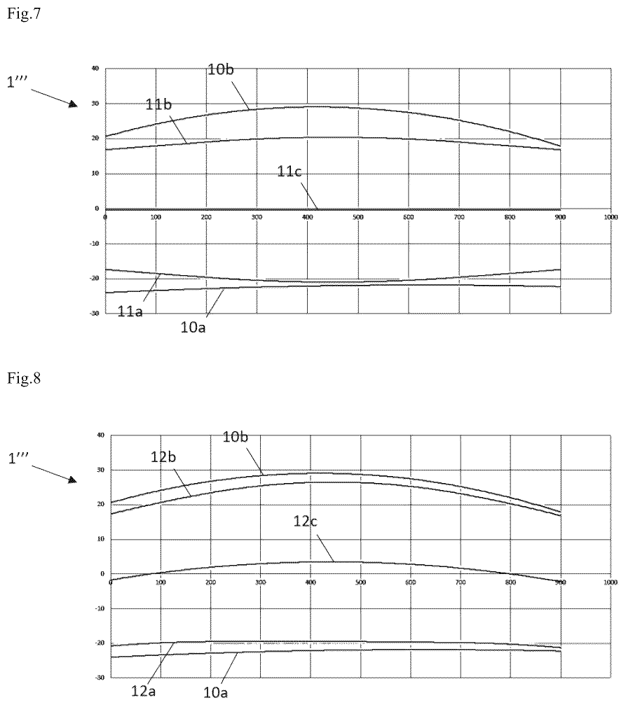

For the fourth strip of wood 1′″ (FIGS. 7 and 8) the machining profile 12a, 12b has a width at the bilge greater by 4.7 mm than the oblong profile 11a, 11b.

This design thus allows to greatly improve the yield in terms of wood of the inclination operation with respect to the curved strips of wood while conserving the same performance in the case of absence of curvature of the strip of wood.

As mentioned above, the method according to the invention is optionally part of a broader method.

According to a first alternative, the calculator 2, for example the tag unit 21, transmits the second piece of data in a third operation 33 to machining means 24, that is to say to any means of the machining machine associated with and/or allowing the machining of the strip of wood according to the machining profile 12a, 12b. Such machining means 24 correspond for example to machining spindles. The calculator 2 corresponds for example to a device remote from the machining machine and configured to communicate with the machining machine, in particular with a robot or computer of the machining machine.

According to a second alternative, the calculator 2, for example an integrated control circuit 23, directly controls the machining of the strip of wood 1, 1′, 1″, 1′″ in a fourth operation 34, for the manufacturing of the stave. In other words, the control circuit 23 is configured to directly control the machining means 24. The calculator 2 corresponds for example to a device integrated into the machining machine, for example into a robot or computer of the machining machine.

Such a machining machine can be comparable to that described in the patent FR3023742B1, for example.

The method according to the invention thus allows to obtain, with minimal losses of material, a stave for the manufacturing of barrels, which has a stave profile 12a, 12b defining a neutral axis 12c having a non-rectilinear shape. Such a stave can be considered to be a curved stave, as opposed to the straight staves known to a person skilled in the art and usually used for the assembly of barrels, casks or other.

It thus appears that this curved stave can be directly used in a method for manufacturing a barrel, casks or a tank. Such a method comprises, as mentioned with regard to the prior art, a bending operation during which the staves are compressed so as to adopt the shape of a barrel, in particular so as to have an arched shape, or bow, that is to say that the two faces of the staves become respectively concave and convex. However, this bending step also contributes to deforming the staves along their edges. According to the disposition and the distribution between the straight and curved staves before bending, that is to say according to the number of straight staves with respect to the number of curved staves, the bending results alternatively in a straightening of the curved staves, resulting in a barrel identical to the prior art, or in the adoption of a curve over all of the staves, resulting in a “coiled” barrel (or tank), the staves of which are curved, the barrel (or the tank) having however the same sealing and mechanical strength properties as the barrels of the prior art.

Thus, it is possible to design a method for manufacturing a barrel or tank from a plurality of staves, the plurality of staves comprising one or more curved staves. Such a method for manufacturing a barrel or tank comprises in particular a step of bending as described above.

Thus, it is understood that the present invention provides a method for determining a profile for machining a stave from a strip of wood, as well as a machining machine cutting out a stave using such a machining profile, which allows to obtain a curved stave allowing an improved yield with respect to the straight staves of the prior art. Such a curved stave can then be used for the manufacturing of barrels, in particular after a compression operation allowing to apply a straight profile thereto.

It should be observed that this detailed description relates to a specific exemplary embodiment of the present invention, but that in no case this description has a nature limiting the object of the invention; on the contrary, the goal thereof is to eliminate any possible imprecision or any incorrect interpretation of the claims that follow.

It must also be observed that the reference signs placed between parentheses in the claims that follow in no case have a limiting nature; the only goal of these signs is to improve the intelligibility and the comprehension of the claims that follow as well as the scope of the protection sought.

1. A method for determining a machining profile for machining the lateral edges of a stave from a strip of wood, the method being implemented by at least one processor, the method comprising:
obtaining a first piece of data representative of a wood strip profile representative of the lateral edges of said strip of wood;
determining a second piece of data representative of the machining profile according to said first piece of data, said machining profile being inscribed in said wood strip profile and having a width changing along said stave,
wherein said machining profile has a neutral axis having a non-rectilinear shape over the width of said stave, said neutral axis following the length of said stave and being disposed at equidistance from said lateral edges of said stave so that said machining profile follows said wood strip profile, maximizes the stave width and minimizes the losses of material between said strip of wood and said stave.

2. The method according to claim 1, wherein said obtaining comprises receiving a piece of dimensional information associated with a plurality of points of said wood strip profile.

3. The method according to claim 2, wherein said obtaining further comprises modelling said wood strip profile according to said piece of dimensional information.

4. The method according to claim 1, wherein said wood strip profile and/or said machining profile are modelled by circular interpolation.

5. The method according to claim 1, wherein said wood strip profile and/or said machining profile are modelled by the use of polynomial equations having a degree greater than or equal to 2.

6. The method according to claim 1 further comprising receiving of a third piece of data representative of a goal for shape of said stave, said second piece of data being further determined according to said third piece of data.

7. The method according to claim 6, wherein the third piece of data comprises a piece of information representative of a ratio between two widths of said stave, said second piece of data being further determined according to said ratio.

8. The method according to claim 1, further comprising transmitting said second piece of data to machining means.

9. The method according to claim 1 further comprising machining said strip of wood for the manufacturing of said stave according to said second piece of data, via machining means.

10. A computer program including instructions for the implementation of the method according to claim 1, when these instructions are executed by a processor.

11. A non-transitory computer readable medium on which a computer program comprising instructions for the execution of the steps of the method according to claim 1 is recorded.

12. A machine for machining a strip of wood for the manufacturing of a stave, said machine comprising a computer means comprising at least a processor as well as machining means controlled by said computer means, said processor being configured for:
obtaining a first piece of data representative of a wood strip profile, in particular representative of the lateral edges of said strip of wood;
determining a second piece of data representative of said machining profile according to said first piece of data, said machining profile being inscribed in said wood strip profile and having a width changing along said stave,
wherein said machining profile has a neutral axis having a non-rectilinear shape over the width of said stave, said neutral axis following the length of said stave and being disposed at equidistance from said lateral edges of said stave so that said machining profile follows said wood strip profile, maximizes the stave width and minimizes the losses of material between said strip of wood and said stave.

13. The machine according to claim 12, wherein said at least a processor is further configured to receive a piece of dimensional information associated with a plurality of points of said wood strip profile.

14. The machine according to claim 13, wherein said at least a processor is further configured to model said wood strip profile according to said piece of dimensional information.

15. The machine according to claim 12, wherein said at least a processor is further configured to model said wood strip profile and/or said machining profile by circular interpolation.

16. The machine according to claim 12, wherein said at least a processor is further configured to model said wood strip profile and/or said machining profile using polynomial equations having a degree greater than or equal to 2.

17. The machine according to claim 12, wherein said at least a processor is further configured to receive a third piece of data representative of a goal for shape of said stave, said second piece of data being further determined according to said third piece of data.

18. The machine according to claim 17, wherein the third piece of data comprises a piece of information representative of a ratio between two widths of said stave, said second piece of data being further determined according to said ratio.

19. The machine according to claim 12, wherein said at least a processor is further configured to transmit said second piece of data to machining means.

20. The machine according to claim 12, wherein said machining means are configured for machining said strip of wood for the manufacturing of said stave according to said second piece of data.

21. A stave for the manufacturing of barrels, wherein said stave has a stave profile defining a neutral axis having a non-rectilinear shape over the width of said stave, said neutral axis following the length of said stave and being disposed at equidistance from said lateral edges of said stave.

22. A method for manufacturing a barrel or tank from a plurality of staves, wherein said plurality of staves comprises at least one stave having a stave profile defining a neutral axis having a non-rectilinear shape over the width of said stave, called curved stave, said neutral axis following the length of said stave and being disposed at equidistance from said lateral edges of said stave.
